(19) United States
(12) Patent Application Publication
(10) Pub. No.: US 2007/0224317 A1
(43) Pub. Date: Sep. 27, 2007

(54) Mixed Fruit Concentrates Againts Constipation and Method for Preparation Thereof

(76) Inventor: Sandra Maria Salles Hanszmann, Centro-Paranza (BR)

Correspondence Address: DAVID A. GUERRA;INTERNATIONAL PATENT GROUP, LLC, 2025 17TH AVENUE N.W., CALGARY, AB, T2M 0S7, CA

(21) Appl. No.: 10/599,895

(22) PCT Filed: May 4, 2005
(86) PCT No.: PCT/BR05/00071

§ 371 Date: Oct. 12, 2006

(30) Foreign Application Priority Data
May 7, 2004 (BR) P10401302-6

(51) Int. Cl. A23L 1/212; A23L 2/02

(52) U.S. Cl. 426/330.5; 426/639

(57) ABSTRACT

The present invention discloses the manufacturing process of mixed fruit concentrate through the mixture of cooked fruits directly or indirectly in vapor, with special nutritional characteristics, for the attainment of formulations of Intestinal Regulating Products, with the intention to take care of the segment of consumers with intestinal constipation and other gastrointestinal problems, given to its attributes of staple fiber source and other nutrients, and that they help in the treatment of the mucosa of the intestine and in the promotion of the regularity of its functioning.

### TECHNICAL FIELD

With the above mentioned invention patent, we present the process of manufacturing mixed fruit concentrates through the mixture of steam cooked fruits, directly or indirectly, with special nutritional characteristics, to attain formulae of Intestinal Regulating Products, focused to take care of the segment of consumers with intestinal constipation and other gastrointestinal problems. Given the attributes of staple fiber source and other nutrients, the products help in the treatment of intestinal mucosa and in the regularity of the intestine.

The ‘arrest of womb’, popular name given to intestinal constipation, currently reaches about twenty percent of the population. In infancy attack, the majority are boys and in adults it's women, however this ratio balances as from sixty years. The causes are diverse, varying from the style of modern life, that includes little staple fiber ingestion, liquids and sedentary life, even to the medicines use, hormone alterations, neurological and muscular pathology, psychiatric situations and anatomical abnormalities of the large intestine. The synptomatology of intestinal constipation is widely varied in a person, as well as from one person to another, but it always brings great repercussions such as: anxiety, indisposition, loss of appetite and change of moods, abdominal distension, chronic headache and nausea and in some cases even fever.

### BACKGROUND ART

Currently the following products are available in the market, with their respective classifications, characteristics, advantages and disadvantages.

Corporate names: Metamucil and Mucilium

Composition: Psylium

Characteristic: Mass formers: They increase the fecal cake, facilitating its passage through the intestine. They are indicated for treatment over long periods, since they act on the physiological form.

Excessive use can provoke fecaloma.

Corporate names: Agiolax and Plantax

Composition: Seed of Plantago Ovatta

Characteristic: Mass formers: They increase the fecal cake, facilitating its passage through the intestine. They are indicated for treatment over long periods, since they act on the physiological form.

Excessive use can provoke fecaloma.

Corporate name: Benefiber

Composition: Agar-Agar

Characteristic: Mass formers: They increase the fecal cake, facilitating its passage through the intestine. They are indicated for treatment over long periods, since they act on physiological form.

Excessive use can provoke fecaloma.

Corporate names: Humectol-D

Composition: sodium picosulfate

Characteristic: Emollients and surfactants: They facilitate the water and fat mixture in the fecal mass, softing it.

They also stimulate the colonic secretion of water, sodium and chlorine.

Corporate names: Magnesia milk

Composition: Magnesia hydroxide

Characteristic: Osmotic laxative: They attract water for the intestinal light since they are osmoticaly active.

They must be administered with caution, especially in older people, due to the risk of hydroelectrolytic disequilibrium.

Corporate names: Lactulona, Farlac and Lactuloson

Composition: Lactulose

Characteristic: Osmotic laxative: they attract water for the intestinal light since they are osmoticaly active.

They must be administered with caution, especially in older people, due to the risk of hydroelectrolytic disequilibrium.

Corporate names: Glycerin (suppository/enema)

Composition: Glycerin

Characteristic: Osmotic laxative: They attract water for the intestinal light since they are osmoticaly active.

They must be administered with caution, especially in older people, due to the risk of hydroelectrolytic disequilibrium.

Corporate names: Mineral oil, Purol and Agarol

Composition: Mineral oil

Characteristic: Lubricant: These are laxatives and they facilitate the movement of the fecal cake, by lubricating the intestinal walls and diminishing water absorption.

They are not considered as good options for long periods, since they cause irritation of the anal canal and inhibit the absorption of fat-soluble vitamins (A, D, E, K).

Corporate names: Homeopatia 46, Agarol, Lactopurga and Purgoleite

Composition: Phenolphthalein

Characteristic: Stimulating and irritating agents: Two chemical groups are included: the diphenilmetaminic derivatives and the anthraquinonics. Both inhibit the absorption of water and electrolytes.

Their indiscriminate and drawn out use lead to the appearance of melanosis colonic and reduce motility due to nervous injury. It provokes the so called “cathartics colon”.

Corporate names: Ducolax and Humectol-D

Composition: Bisacodil

Characteristic: Stimulating and irritating agents: Two chemical groups are included: the diphenilmetaminic derivatives and the anthraquinonics. Both inhibit the absorption of water and electrolytes.

Their indiscriminate and drawn out use leads to the appearance of melanosis colonic and reduce the motility due to nervous injury. It provokes the so called “cathartics colon”.

Corporate name: Guttalax

Composition: Sodium picosulfate

Characteristic: Stimulating and irritating agents: Two chemical groups are included: the diphenilmetaminic derivatives and the anthraquinonics. Both inhibit the absorption of water and electrolytes.

Their indiscriminate and drawn out use leads to the appearance of melanosis colonic and reduce motility due to nervous injury. It provokes the so called “cathartics colon”.

Corporate names: Sacred Cáscara Sagrada, Ventre Livre and Purgoleite

Composition: Cáscara Sagrada

Characteristic: Stimulating and irritating agents: Two chemical groups are included: the diphenilmetaminic derivatives and the anthraquinonics. Both inhibit the absorption of water and electrolytes.

Their indiscriminate and drawn out use leads to the appearance of melanosis colonic and reduce motility due to nervous injury. It provokes the so called “cathartics colon”.

Corporate names: Agiolax, Plantax, Florax, Laxtan, Tamarine, Tamaril, Novolax, Tamarix, Frutalax, Laxarine and Laxarine

Composition: Sene

Characteristic: Stimulating and irritating agents: Two chemical groups are included: the diphenilmetaminic derivatives and the anthraquinonics. Both inhibit the absorption of water and electrolytes.

Its indiscriminate and drawn out use leads to the appearance of melanosis colonic and reduce motility due to nervous injury. It provokes the so called “cathartics colon”.

### TECHNICAL PROBLEM

“THE MANUFACTURING PROCESS OF MIXED FRUIT CONCENTRATES AND THE FORMULATION OF CORRESPONDING INTESTINAL REGULATING PRODUCTS.”

Object of the present patent, was developed to surpass the inconveniences and limitations of the currently existing products. Therefore in view of the magnitude of this problem and the great repercussion that it can cause to the individual, brought about the development of products or composites necessary, containing staple fibers and other nutrients, that help to deal with the intestine mucosa and promote the regularity of the intestine, and most important of all, does not cause greater damages, being able to be used with greater freedom, for the most varied group of people, at a time when many products sold under the label of “natural” can cause serious damages for its irritating effect on the mucosa and the neuromotor intestinal system, not being able to be used by long periods of time and nor in physiological situations special as in pregnancy and infancy.

### TECHNICAL SOLUTION

Therefore, from the cited objectives and of innumerable researches, a mixture of cooked fruits was developed, which are able to promote the desired regularity of the intestine. This rich synergetic mixture in soluble staple fibers contains a series of vitamins and minerals, beyond other composites that make this product a functional food, that acts as mass former for the staple fiber presence and as an agent stimulant for the presence of some fruits, but without the irritating effect.

### ADVANTAGEOUS EFFECTS

The formularizing of intestinal regulating products of the present patent comes with a series of advantages; as already cited apart from staple fibers, it contains vitamins and minerals, mainly carotene and vitamins of the B complex and other composites such as bromelin, ficine and papain and does not contain Sene, which is a stimulating and irritating agent that causes intestinal mucosa. It does not possess any adverse effect or any significant collateral effect, only a pleasant aspect and flavor. The products, mashed or cooked fruits, are composed of up to 7 fruits, where each one confers particular properties to the product, besides supplying considerable value of soluble staple fibers. These fruits have been selected mainly from their known laxative effect and also by the exemption of irritating intestinal mucosa composition, enabling safe usage for the most diverse group of people, varying from children up to pregnant women, thus becoming a product of unique application in the market.

The base of the development of the object of the present patent is based on the properties of the fruits that compose the mixture of the product:

Papaya apart from its laxative properties is rich in antirust nutrients, such us carotene, vitamin C and flavonoides, which in turn helps to protect and to treat the already infected intestinal mucosa. Also contains good volumes of numerous minerals, especially potassium and magnesium and papain that is been used in the combat the diverse problems, amongst them indigestion, mainly for its proteolytic and anti-inflammatory action. Pineapple is rich in vitamin C and potassium and contains bromelin, an enzyme similar to papain of the papaya. Bromelin was first used as a medicinal agent in 1957, and since then has had more than 200 published scientific works in medical literature on its therapeutical application. Its benefits include: facilitating digestion through innumerable processes, mainly for its proteolytic action; reducing inflammation and edemas; inhibiting plaquetary aggregation; controlling appetite and speeding up cicatrization among other functions, reducing flatulence.

The apple supplies great amounts of soluble staple fibers through pectin, which increases the volume of the fecal cake and improves the capacity of the intestinal muscle to push. It also contains acid ellagic, clorogenic and coffeic, coadjuvantes of the anticarcinogenic action. It also possess quercitrin, a protective flavonoide against cardiovascular illnesses, sweeper of free radicals and preventive of carcinogenesis, besides acting as protective gastric, for increasing the production of mucous in the stomach.

Plum is well known for its high laxative quality, besides offering good sources of carotene, flavonoides, potassium and iron.

Fig contains mainly minerals such as calcium, iron and potassium and its seeds also supplies an active and mild laxative by stimulating the muscles of the intestine. Added to these benefits, fig possesses an enzyme called ficine that has proteolytic action, widely employed in the pharmaceutical industry for its anti-helminthic action.

Apricot, rich in soluble staple fibers, betacarotene, potassium, iron and copper.

Therefore after analyzing all the cited data, it is reasonable to conclude that the composition of the mixed fruit concentrates clearly bring numerous benefits. Mainly when dealing with the treatment of mucosa and the regularity of the intestine. It is suggested that the treatment of mucosa should be done mainly with antirust vitamins, with scaring properties, as well as for other cited composites, such as quercitrin and bromelin. Whereas intestinal regularity is mainly reached by the increase of the staple fiber consumption, that also exert influence on appetite, bringing about weight loss.

In the research carried out for the attainment of the optimized formula, a series of formulae were tested, some are as follows:

1—Infantile Intestinal Regulator—Prescription of Papaya, with Pineapple, Apple, Pear and Plum measures

1200 g. Papaya (without peel or seed)

330 g of apple (3 peeled small apples, without seed)

330 g of pear (3 peeled small pears, without seed)

300 g of plum

250 g of pineapple (without peel and core)

250 g of sugar or

175 ml of concentrated apple juice+

50 g of fructose

Sequence of Adopted Process:

Wash the plums and place them in a boiler (150 ml water) to soften. The boiler must be covered. After twenty minutes, remove from the boiler and place in a pot together with the steamed water from the boiler, cover the pot and leave to cook, stirring regularly until the pulp is separated from the seed. Remove the seeds and store the pulp in a cool place.

Wash, peel and remove the seeds and core of the other fruits. Cut fruits in small chunks and cook over an open fire in a covered pot till soft (that is when the apple and the pineapple can be easily perforated with a fork), take off the cover and boil until a half of the liquid has dried. Beat the boiled fruits together with the plum in a blender. Strain the pulp to remove the not soluble staple fibers of the pineapple. Place in a pan, add sugar or concentrated apple juice, mix and heat until 28/32° Brix. In the case of use concentrated apple juice add plus fructose then mix and heat no more one minute, bottle off.

2—Day to Day Intestinal Regulator—Prescription of Papaya, Pineapple, Apple, Dried Plum and Plum

Measures:

1200 g. Papaya (without peel or seed)

400 g of pineapple (without peel and core)

330 of mace (3 small apples peeled, without seed)

330 g of plum

66 g of black dried plum without seed

200 g of sugar or

175 ml of concentrated apple juice+

50 g of fructose

Sequence of Adopted Process:

Wash the plums and together with the dried plums, place them in a covered boiler (150 ml. water). After twenty minutes, remove from the boiler and place in a pot together with the steamed water from the boiler, cover the pot and leave to cook, stirring regularly until the pulp is separated from the seed. Remove the seeds and store the pulp in a cool place.

Wash, peel and remove the seeds and core of the other fruits. Cut fruits in small chunks and cook over an open fire in a covered pot till soft (that is when the apple and the pineapple can be easily perforated with a fork), take off the cover and boil until a half of the liquid has dried. Beat the boiled fruits together with the plum in a blender. Strain the pulp to remove the not soluble staple fibers of the pineapple. Place in a pan, add sugar or concentrated apple juice, mix and heat until 28/32° Brix. In the case of use concentrated apple juice add plus fructose then mix and heat no more one minute, bottle off.

3—Day to Day Intestinal Regulator with Fig—Prescription of Papaya, Pineapple, Apple, Plum and Fig

Measures:

1200 g papaya (without peel or seed)

600 g of figs (8 figs)

400 g of pineapple (without peel or core)

330 g of apple (3 average apples peeled, without seed)

330 g of plum

200 g of sugar or

175 ml of concentrated apple juice+

50 g of fructose

Sequence of Adopted Process:

Wash the plums and place them in a covered boiler (150 ml. water). After twenty minutes, remove from the boiler and place in a pot together with the steamed water from the boiler, cover the pot and leave to cook, stirring regularly until the pulp is separated from the seed. Remove the seeds and store the pulp in a cool place.

Wash, peel and remove the seeds and core of the other fruits. Cut fruits in small chunks and cook over an open fire in a covered pot till soft (that is when the apple and the pineapple can be easily perforated with a fork), take off the cover and boil until a half of the liquid has dried. Beat the boiled fruits together with the plum in a blender. Strain the pulp to remove the not soluble staple fibers of the pineapple. Place in a pan, add sugar or concentrated apple juice, mix and heat until 28/32° Brix. In the case of use concentrated apple juice add plus fructose then mix and heat no more one minute, bottle off.

4—Intestinal Regulator—Prescription of Papaya, Fig, Pineapple, Apple, Plum and Dried Plum

Measures:

1200 g papaya (without peel or seed)

600 g of figs (8 figs)

400 g of pineapple (without peel or core)

330 g of apple (3 average apples peeled, without seed)

330 g of plum

66 g of black dry plum without seed

200 g of sugar or

175 ml of concentrated apple juice+

50 g of fructose

Sequence of Adopted Process:

Wash the plums and together with the dried plums, place them in a covered boiler (150 ml. water). After twenty minutes, remove from the boiler and place in a pot together with the steamed water from the boiler, cover the pot and leave to cook, stirring regularly until the pulp is separated from the seed. Remove the seeds and store the pulp in a cool place.

Wash, peel and remove the seeds and core of the other fruits. Cut fruits in small cunks and cook over an open fire in a covered pot till soft (that is when the apple and the pineapple can be easily perforated with a fork), take off the cover and boil until a half of the liquid has dried. Beat the boiled fruits together with the plum in a blender. Strain the pulp to remove the not soluble staple fibers of the pineapple. Place in a pan, add sugar or concentrated apple juice, mix and heat until 28/32° Brix. In the case of use concentrated apple juice add plus fructose then mix and heat no more one minute, bottle off.

5—Intestinal Regulator Plum Flavor—Prescription of Papaya, Pineapple, Apple, Fig, Black Dried Plum and Plum

Measures:

1200 g papaya (without peel or seed)

600 g of figs (8 figs)

400 g of pineapple (without peel or core)

330 g of apple (3 small apples peeled, without seed)

250 g of plum

200 g of black dry plum without seed

85 g of sugar or

175 ml of concentrated apple juice+

50 g of fructose

Sequence of Adopted Process:

Wash the plums and together with the dried plums, place them in a covered boiler (150 ml. water). After twenty minutes, remove from the boiler and place in a pot together with the steamed water from the boiler, cover the pot and leave to cook, stirring regularly until the pulp is separated from the seed. Remove the seeds and store the pulp in a cool place.

Wash, peel and remove the seeds and core of the other fruits. The stem of the fig must be removed and for safety purposes all fig must be cut in half. Cut fruits in small chunks and cook over an open fire in a covered pot till soft (that is when the apple and the pineapple can be easily perforated with a fork), take off the cover and boil until a half of the liquid has dried. Beat the boiled fruits together with the plum in a blender. Strain the pulp to remove the not soluble staple fibers of the pineapple. Place in a pan, add sugar or concentrated apple juice, mix and heat until 28/32° Brix. In the case of use concentrated apple juice add plus fructose then mix and heat no more one minute, bottle off.

6—Intestinal Regulator with Apricot—Prescription of Papaya, Pineapple, Apple, Fig, Apricot, Black Dried Plum and Plum

Measures:

1200 g papaya (without peel or seeds)

600 g of figs (8 figs)

400 g of pineapple (without peel or core)

330 g of apple (3 small apples peeled, without seed)

330 g of plum

66 g of black dry plum without seed

66 g of apricot

200 g of sugar or

175 ml of concentrated apple juice+

50 g of fructose

Sequence of Adopted Process:

Wash the plums and together with the apricot and dried plums, place them in a covered boiler (150 ml. water). After twenty minutes, remove from the boiler and place in a pot together with the steamed water from the boiler, cover the pot and leave to cook, stirring regularly until the pulp is separated from the seed. Remove the seeds and store the pulp in a cool place.

Wash, peel and remove the seeds and core of the other fruits. The stem of the fig must be removed and for safety purposes all fig must be cut in half. Cut fruits in small chunks and cook over an open fire in a covered pot till soft (that is when the apple and the pineapple can be easily perforated with a fork), take off the cover and boil until a half of the liquid has dried. Beat the boiled fruits together with the plum and the apricot in a blender. Strain the pulp to remove the not soluble staple fibers of the pineapple. Place in a pan, add sugar or concentrated apple juice, mix and heat until 28/32° Brix. In the case of use concentrated apple juice add plus fructose then mix and heat no more one minute, bottle off.

Comments on the Various Formulae:

1—The infantile version is sufficiently rich in papaya, conferring together with the pear mild action in laxative terms, while offering a flavor of easy acceptance for children between 1 and 4 years.

2—The version day to day, without fig, is very mild and it is indicated or for sensitive people or for children between 4 and 6 years.

3—The version with fig and plum in nature without dry plum is a solution for those cases where the prescriptions with black plum make the product more expensive.

4—The version with fig, plum and dry plum is the formula that obtained the best results in a general way of acceptance. It is active enough and does not cause colic or any other undesirable reaction.

5—The versions plum is for people who have better results with black plum.

6—The version with apricot is for people with serious intestinal constipation because the apricot when mixed with all the other fruits, besides conferring a sophisticated and peculiar taste, increases the laxative function.

After the research was concluded, the optimized formulation possess the following compositions in weight, in the case of adult use:

| FRUIT | PERCENTAGE |
|---|---|
| Papaya (Formosa) | 35 to 42 |
| Fig | 17 to 25 |
| Pineapple | 13 to 19 |
| Apple | 10.5 to 15 |
| Plum | 9 a 13 |
| Dry Plum | 0 to 7 |
| Dry Apricot | 0 to 4 |
| Sugar | 0 to 10 |
| Concentrated apple juice | 0 to 9 |
| Fructose | 0 to 7 |
| Thickening agent | 0.2 to 0.4 |
| Acidulate agent | Qsp |
| Preservative agent | Qsp |

The acidulate agent could be citric acid, tartaric acid, malic acid, fumaric acid, lemon juice or any other allowed by the legislation.

The thickening agent could be modified starch, gum to guar, xantana, carragena gum, carboxymethylcellulose, Arabic gum, Jatai gum- or others allowed by the legislation.

The Preservative agent could be sorbic acid and its salts of sodium, potassium and calcium, acid benzoic and its salts of sodium, potassium and calcium or other allowed by the legislation.

The justification for the chosen percentages is as follows:

The papaya cannot be very green or very ripe. When green it modifies the taste of the end product. When very ripe it makes the product very watery, modifying the consistency and loses a lot with peeling, making the correction factor very high, increasing the cost of the product. It is the fruit with a greater percentage in the formulation, therefore it functions basically as a vehicle for all the other components of the formulation, helping in the baking of the fruits that are less watery and is available for the purchase throughout the year. When the percentage is increased the product becomes too watery and when lowered it loses efficiency.

The fig similar to the papaya cannot be too ripe nor too green. When it's too green the taste of the product becomes unpleasant and when too ripe, disintegrates during cooking, losing its laxative capacity. In lower percentages the product loses its effectiveness, mainly by reducing dramatically the staple fiber content. In larger amounts the product becomes commercially impracticable due to the high cost of the fruit.

The pineapple when too green confers exaggerated acidity to the product making it unpalatable. In lower percentages it is difficult to process, since like the papaya it functions as a baking vehicle for the other fruits. In larger amounts it has low tolerance for some people, mainly those who have gastric problems such as gastritis, esophagitis and sour stomach among others. Besides all the properties it is available throughout the year.

The apple most preferential type is “fuji”, when too green its acidity becomes unpalatable in the product.

The apple of a more acid nature is the preferably used because of the manufacture of natural pectin, and it also helps to solidify the mixed fruit concentrates. If used in less than the indicated amount, the ideal consistency would not be reached and in greater amounts increases the pectin and this could cause the inverse effect, provoking intestinal constipation. Moreover, the apple confers a pleasant taste, neutralizing the acidity of the other fruits, it is not a very expensive fruit and it is available throughout the year.

The plum, when too green confers high acidity to the product making it impracticable. The amount used is enough to reach the laxative intention, without increasing the cost of the product since this fruit is not available in Brazil the whole year. Besides the properties, it confers a pleasant taste and composing with the dried plum, which is very expensive, offers an important staple fiber amount at a more reasonable price.

The dried plum is optional. In the formulation, although in small amounts, it represents comparative proportions to the other fruits in the same conditions. In larger amounts, it represents a higher ratio of staple fibers. Besides the properties, it is sweet and helps to neutralize the acidity of the other fruits and reduces the amount of sugar added to the product. Less than the indicated amount is not recommended since it is the minimum amount necessary to guarantee the desired laxative effect.

Larger quantities are not used because of the amount of staple fibers. Where the staple fibers are greater, the user would have to include large quantities of liquids on a daily basis and most people do not have this habit, thus the inverse effect would occur. Instead of being a laxative, mixed fruit concentrates could cause constipation. Apart from these arguments, dried plum is an expensive product, which is quoted in dollar, and depending on the quantity used, the product could become unfeasible.

Apricot is also optional. In the formulation, although in small amounts, for being in a dry state, represents when compared proportionally to the other fruits in the same conditions, a great amount, mainly when it relates to the ratio of staple fibers. Besides the properties, it confers to the product a sufficiently sophisticated and interesting taste. Less than the indicated amount is not recommended because this is the minimum amount necessary to guarantee the desired effect to increase the fecal cake. On the other hand, larger amounts are not recommended because of the amount of staple fibers would also be greater and in this in case the user would have to have a diet of large quantities of liquids daily. Since most people do not have this habit, instead of being a laxative, mixed fruit concentrates could have the inverse effect. Apart from these arguments, apricot is even more expensive than dried plum and depending on the quantity used, the product could become unfeasible.

Sugar or concentrated apple juice and fructose are in the range of its maximum amount. This is the ideal amount so that the mixed fruit concentrates become pleasantly edible and can be eaten by the spoonfuls.

After the research was concluded, the optimized formulations possess the following compositions in weight, in the case of children use:

| FRUIT | PERCENTAGE |
|---|---|
| Papaya (Formosa) | 41 to 47 |
| Apple | 11.5 to 12.5 |
| Pear | 11.5 to 14 |
| Plum | 11 to 14 |
| Pineapple | 9.5 to 10.5 |
| Sugar | 0 to 12 |
| Concentrated apple juice | 0 to 10 |
| Fructose | 0 to 8 |
| Thickening agent | 0.2 to 0.4 |
| Acidulate agent | Qsp |
| Preservative agent | Qsp |

The acidulate agent could be citric acid, tartaric acid, malic acid, fumaric acid, lemon juice or any other allowed by the legislation.

The thickening agent could be modified starch, gum to guar, xantana, carragena gum, carboxymethylcellulose, Arabic gum, Jatai gum- or others allowed by the legislation.

The Preservative agent could be sorbic acid and its salts of sodium, potassium and calcium, acid benzoic and its salts of sodium, potassium and calcium or other allowed by the legislation.

The justification for the chosen percentages is as follows:

The papaya as in the previous formula does not have to be too ripe nor too green excess for reasons already mentioned. The percentage is more than in the original formulas mainly to compensate the percentages that are lower, for example, that of the pineapple. In lower percentages it loses consistency of the product and in higher percentages the product loses its efficiency.

The apple had its percentage increased mainly to increase the consistency of the mixed fruit concentrates which lost consistency due to the increase of the volume of papaya, however this is the maximum amount recommended, otherwise the efficiency of the product will be affected due to the high content of pectin which has been added to the formula.

The pear when it's too green confers an unpleasant taste to product and when it's too ripe becomes very watery, loses consistency and it does not help to give bind to the product, besides having its correction factor very high, it also increases the price of the product. For its mild laxative property it confers to the infantile intestinal a less aggressive combination, mainly for children over two and under four years. Besides the properties, in this amount the pear helps to neutralize the acidity of the other fruits, without increasing the price of the product and it's available throughout the year.

The plum is in similar percentages as in the previous formula.

The pineapple has had a reduction in percentage to make the product more palatable for children between 2 to 4 years, however if lower further, would cause the product to lose its properties.

The sugar or concentrated apple juice and fructose was also increased so that the flavor would become more adequate to the infantile public.

### DESCRIPTION OF DRAWINGS

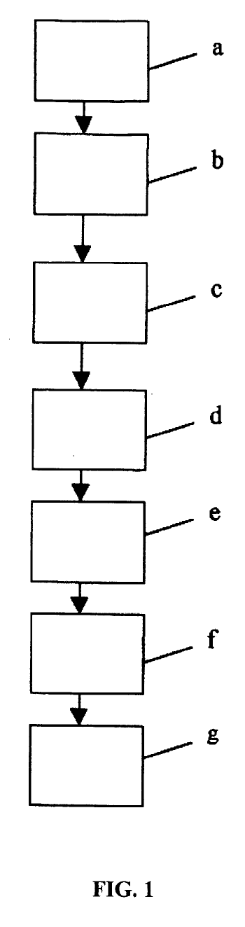

For better understanding of the present object of the patent FIG. 1 has been attached with the block diagram of the process.

The Manufacturing Process of mixed fruit concentrates is given in the following sequence:

a) Clean and cut the pineapple in cubical pieces of 3 to 4 cm and place them in boiler 1 with indirect water vapor heating until soft (the adequate point is when the pieces of the pineapple can be easily perforated with a fork);

b) Cook with water for 10 to 20 minutes, remove then beat in a blender and strain to remove the fibers of the pineapple (the size of the strainer has holes that allow strawberry seeds to pass). Transfer the pulp to boiler 3, together with the pulp of the other fruits.

c) Wash the plums and remove the seeds then place them together with the dried plum and the other fruits duly washed, peeled, unseeded and cut in the size of cubical pieces of 3 to 4 cm, the exception is the fig which must be cut to removed only the stem.

d) All these fruits must be cooked in water for approximately 20 to 30 minutes in boiler 2 with indirect water vapor heating, stirring constantly until soft or until the apple pieces can be easily perforated with a fork.

e) When ready, remove from the fire and beat in the blender.

f) Transfer this fruit pulp to boiler 3 with indirect water vapor heating with the pulp of the pineapple, adding sugar or concentrated apple juice and thickening agent until it reaches around 28 to 36° Brix, mixing and heating between 90 to 95° C., adding acidulate agent, the necessary preservative agents and finally fructose if apple juice concentrated was used. In this case, stop heating one minute after introduction.

g) At this temperature the product must be bottled and kept between 30 to 40 minutes in bains-marie.

Alternatively, the plums could be pre-cooked in direct vapor, in a separate-covered boiler till soft. After 15 minutes, they must be removed and placed in boiler with the water from the vapor. Covered the boiler in which the plums are being cooked, stirring constantly until the seeds are separated. Remove the seeds and beat in a blender, then leave the pulp in a cool place. When the pulp of the other fruits is ready, transfer the pulp of the plums to boiler 3.

Alternatively, the pineapple could be cooked with all the fruits and in this in case, all the fruits will be beaten together the blender and must be strained after to remove the fibers of fiber the pineapple.

Alternatively, sterilization could be complemented by the action of gamma rays or any other type of radiation allowed by the legislation, or use autoclave.

### INDUSTRIAL APPLICABILITY

Aiming to simplify the fabrication and enjoy the benefits of optimum control of the origin of the fruits, including certification and mainly reducing the cost of labor in the initial stage of fabrication (washing and peeling), whenever possibly, substitute the natural fruit with fruit pulp.

Irrespective of the fruit being in it's natural or in pulp form, the weighing and fabrication process is basically the same as described. Normally we use pulp for papaya, apple and pineapple, while for fig and plums, the natural form is preferred due to seasonality.

a) Wash the plums and remove the seed, wash, peel and cut the figs without stem, mixed them in a blender.

b) Strain the pineapple to remove the staple fiber, transfer it to the boiler with the others fruits.

c) Mix and steam cook all the fruits in a boiler with vapor heating directly or indirectly, add sugar or concentrated apple juice, add thickening agent until it is reaches 28° to 36° Brix, stirring constantly and keeping the temperature at 90° to 95° C., add acidulate and preservative agents and finally fructose if apple juice concentrated was used. In this case, stop heating one minute after introduction.

d) Bottle off the product and place in bains-marie for 30 to 40 minutes or use autoclave.

1. THE FORMULA OF MIXED FRUIT CONCENTRATES THAT CORRESPONDS TO AN INTESTINAL REGULATING PRODUCT”, characterized by, percentage of the composition of the product, with:

| FRUIT | Percentage |
|---|---|
| Formosa papaya | 35 to 47 |
| Pineapple | 9.5 to 19 |
| Apple | 10.5 to 15 |
| Plum | 9 to 14 |
| Dry Plum | 0 to 7 |
| Dry Apricot | 0 to 4 |
| Fig | 0 to 25 |
| Pear | 0 to 14 |
| Sugar | 0 to 10 |
| Concentrated apple juice | 0 to 9 |
| Fructose | 0 to 7 |
| Thickening agent | 0.2 to 0.4 |
| Acidulate agent | 0 to 3 |
| Preservative agent | 0.045 to 0.1 |

2. THE FORMULA OF MIXED FRUIT CONCENTRATES THAT CORRESPONDS TO AN INTESTINAL REGULATING PRODUCT”, according to claim 1, characterized by, percentage of the composition of the product for adults, with:

| FRUIT | Percentage |
|---|---|
| Formosa papaya | 35 to 42 |
| Fig | 17 to 25 |
| Pineapple | 13 to 19 |
| Apple | 10.5 to 15 |
| Plum | 9 to 13 |
| Dry Plum | 0 to 7 |
| Dry Apricot | 0 to 4 |
| Sugar | 0 to 10 |
| Concentrated apple juice | 0 to 9 |
| Fructose | 0 to 7 |
| Thickening agent | 0.2 to 0.4 |
| Acidulate agent | 0 to 3 |
| Preservative agent | 0.045 to 0.1 |

3. THE FORMULA OF MIXED FRUIT CONCENTRATES THAT CORRESPONDS TO AN INTESTINAL REGULATING PRODUCT”, according to claim 1, characterized by, percentage of the composition of the product for children, with:

| Fruit | Percentage |
|---|---|
| Formosa papaya | 41 to 47 |
| Apple | 11.5 to 12.5 |
| Pear | 11.5 to 14 |
| Plum | 11 to 14 |
| Pineapple | 9.5 to 10.5 |
| Sugar | 0 to 10 |
| Concentrated apple juice | 0 to 9 |
| Fructose | 0 to 7 |
| Thickening agent | 0.2 to 0.4 |
| Acidulate agent | 0 to 3 |
| Preservative agent | 0.045 to 0.1 |

4. “THE MANUFACTURING PROCESS OF MIXED FRUIT CONCENTRATES THAT CORRESPONDS TO AN INTESTINAL REGULATING PRODUCT”, characterized by the following sequence:
a) Clean, peel, un-seed and cut the pineapple, the formosa papaya, the apple, the fig and the pear in cubical pieces of 3 to 4 cm, except for the fig to that must have the stem removed and cut in two pieces; wash the plums and remove the seeds; later place the plums together with the dried plums and the dried apricots, the pineapple, the formosa papaya, the apple, the fig and the pear;
b) Put the pineapple, the formosa papaya, the apple, the fig, the pear, the plums, the dried plums and dried apricots in boiler 1 with indirect water vapor heating and cook it for approximately 20 to 30 minutes with, constantly stirring, until are tender but still retain their shape;
c) Remove the fruits from the boiler 1 and beat them in the blender; then strain to remove the fiber from the pineapple, the size of the strainer is 5 mm (strainer which allows the passage of strawberries seeds), then transfer the pulp to boiler 2;
d) This fruit pulp must be cooked in boiler 2 with indirect water vapor heating, adding sugar or concentrated apple juice and thickening agent until reaching around 28° to 36° Brix, mixing, heating between 90° to 95° C., adding the necessary acidulate and preservative agents and in the case of use concentrated apple juice, adding plus fructose, then mix and heat no more than one minute;
e) At this temperature the product must be bottled and kept between 30 to 40 minutes in bains-marie or use autoclave.
